(19) United States
(12) Patent Application Publication
(10) Pub. No.: US 2022/0405608 A1
(43) Pub. Date: Dec. 22, 2022

(54) GEOMETRIC REPRESENTATION FOR RULE INDUCTION FROM KNOWLEDGE GRAPHS

(71) Applicant: International Business Machines Corporation, Armonk, NY (US)

(72) Inventors: Ankita Likhyani Grover, New Delhi (IN); Shajith Ikbal Mohamed, Chennai (IN); Hima Prasad Karanam, Bangalore (IN); L. Venkata Subramaniam, Gurgaon (IN)

(21) Appl. No.: 17/350,227

(22) Filed: Jun. 17, 2021

(51) Int. Cl. G06N 5/02; G06K 9/62

(52) U.S. Cl. CPC G06N 5/025; G06K 9/628; G06K 9/6252

(57) ABSTRACT

In a method for deriving existential rules from knowledge graph data, a processor represents a knowledge graph using a geometric embedding. A processor transforms the geometric embedding to a syllogism logic representation using a geometric relationship. And a processor derives existential rules using standard transformation rules present in the syllogism logic representation.

### BACKGROUND

The present invention relates generally to the field of knowledge graphs, and more particularly to generating rules from embeddings in a knowledge graph.P

In knowledge representation and reasoning, knowledge graph is a knowledge base that uses a graph-structured data model or topology to integrate data. Knowledge graphs are often used to store interlinked descriptions of entities—objects, events, situations or abstract concepts—with free-form semantics. Entities are represented by nodes, and facts by relationships between the nodes. Many large knowledge graphs have been created over the last several years to support intelligent applications. These intelligent applications (e.g., question answering, fact checking, and knowledge graph completion) employ rules derived from the data in the knowledge graph to successfully infer additional facts and provide conclusions to a user. The rules are generally written manually, or generated based on nodes and relational information in the knowledge graph. These rules or constraints on the data are also referred to as ontology information for a given knowledge graph. The use of diagrams in formal logic reasoning has generated a great deal of interest in recent years due to the need to visualize complex logic problems that are difficult to understand. The term diagram refers to a graphical representation of how objects in a domain are interconnected or interrelated to one another. In logic reasoning, the central diagram in question is the Venn diagram, a well-known diagramming technique that is used to graphically represent relations among sets.

### SUMMARY

According to one embodiment of the present invention, a computer-implemented method, a computer program product, and a computer system are provided for deriving rules for a knowledge graph. The rules derived for the knowledge graph provide additional data for deductive and inductive reasoning by intelligent applications. A processor derives existential rules from knowledge graph data. A processor represents a knowledge graph using a geometric embedding. A processor transforms the geometric embedding to a syllogism logic representation using geometric relationships. A processor derives existential rules using standard transformation rules present in the syllogism logic representation.

According to one embodiment of the present invention, a computer-implemented method is provided for deriving rules for a knowledge graph. These rules improve the ability for intelligent application to meaningfully interpret data contained within the knowledge graph. A processor divides a knowledge graph into classes. A processor organizes geometric embeddings for entities in the knowledge graph. A processor constructs premises. The premises may include syllogistic relationships for a pair of classes. A processor transforms the geometric embeddings into Venn diagrams. A processor transforms the Venn diagrams into Venn diagrams with shading and x-sequence using the premises. A processor derives conclusive rules using the Venn diagrams with shading and x-sequence.

According to one embodiment of the present invention, a computer-implemented method is provided for deriving rules for a knowledge graph. These rules improve the ability for intelligent application to meaningfully interpret data contained within the knowledge graph. A processor divides a knowledge graph into classes. A processor organizes geometric embeddings for entities in the knowledge graph. A processor constructs premises. The premises may include syllogistic relationships for a pair of classes. A processor transforms the geometric embeddings into Carroll's diagrams. A processor transforms, using the premises, the Carroll's diagrams into transformed Carroll's diagrams having 1's or 0's. A processor derives conclusive rules using the transformed Carroll's diagrams.

### BRIEF DESCRIPTION OF THE DRAWINGS

FIG. 1 is a functional block diagram illustrating a rules generating environment, in accordance with an embodiment of the present invention;

FIG. 2 is a flowchart depicting operational steps of a rules generating program, in accordance with an embodiment of the present invention;

FIG. 3 is a diagram depicting representations of geometric embeddings, in accordance with an embodiment of the present invention;

FIG. 4A is a chart representing geometric relationships of the geometric embeddings derived by the rules generator in accordance with one embodiment of the present invention;

FIG. 4B is a chart representing transformed geometric embeddings, as transformed by the rules generator in accordance with one embodiment of the present invention;

FIG. 4C is a chart depicting syllogism logic representations, in accordance with one embodiment of the present invention;

FIG. 5A is a chart depicting a unified diagram, in accordance with an embodiment of the present invention;

FIG. 5B is a chart depicting a resolved unified diagram, in accordance with one embodiment of the present invention;

FIG. 6 is a chart depicting a conclusion diagram, in accordance with one embodiment of the present invention;

FIG. 7 is a chart depicting a conclusion diagram, in accordance with one embodiment of the present invention;

FIG. 8 is a chart depicting a unified diagram, in accordance with an embodiment of the present invention;

FIG. 9 is a chart depicting a conclusion diagram, in accordance with one embodiment of the present invention;

FIG. 10 is a chart depicting a conclusion diagram, in accordance with one embodiment of the present invention;

FIG. 11 is a chart depicting a Carroll's representation of three classes, in accordance with one embodiment of the present invention;

FIG. 12 is a chart depicting a trilateral diagram of syllogism logic representations, in accordance with one embodiment of the present invention;

FIG. 13 is a chart depicting a bilateral diagram as transformed by the transformation rules, in accordance with one embodiment of the present invention; and

FIG. 14 depicts a block diagram of components of a computing device 1400 in accordance with an illustrative embodiment of the present invention.

### DETAILED DESCRIPTION

The disclosed embodiments include a framework for learning rules from a knowledge graph. The framework uses logical relationships, such as those represented in diagrams (e.g., Venn diagrams, Carroll's diagrams), to construct logic proofs.

Knowledge graphs are typically constructed in a format known as semantic triple format, a semantic triple, Resource Description Framework (RDF) triple, or simply “triple.” The triple is the atomic data entity in knowledge graphs. As its name indicates, a triple is a set of three entities that codifies a statement about semantic data in the form of subject—predicate— object expressions (e.g., John is 38, or Bob knows John). The triple format representation of knowledge graphs is effective in representing structured data, but the underlying symbolic nature of such triples usually makes knowledge graphs hard to manipulate.

To improve manipulation of the data within the knowledge graph, and support intelligent applications using the data within the knowledge graph, the embodiments disclosed herein use knowledge graph embedding, which is a process by which a system embeds entities and relations into continuous vector spaces. This knowledge graph embedding simplifies the manipulation while preserving the inherent structure of the knowledge graph. Current embedding techniques, however, are prohibitively restrictive in capturing existential rules. Comprehensive integration of neural embeddings and Knowledge Representation is required to develop methods that combine deductive and inductive reasoning in a tighter way than current approaches.

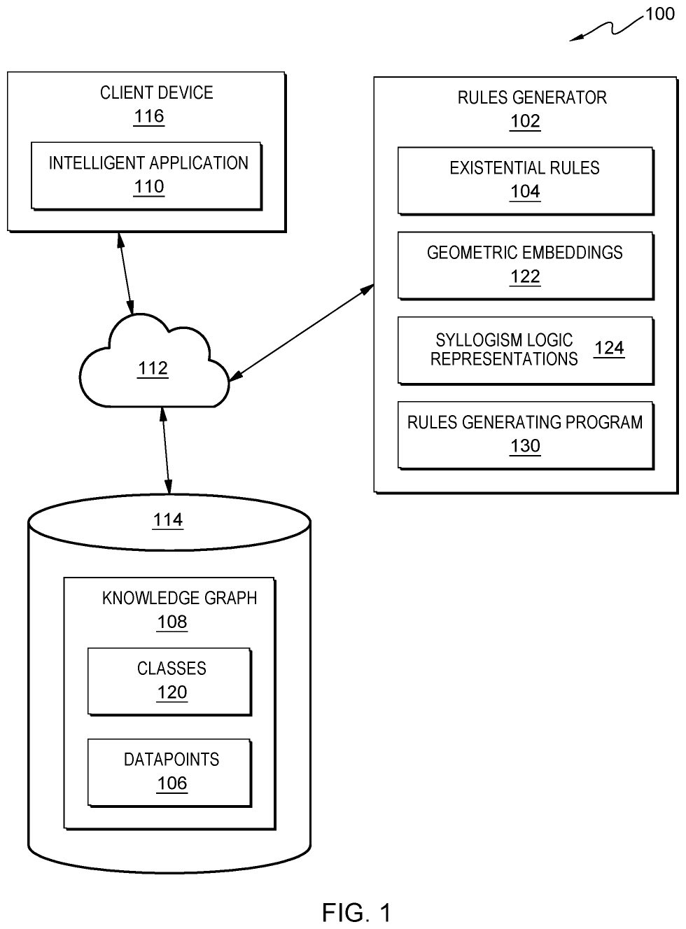

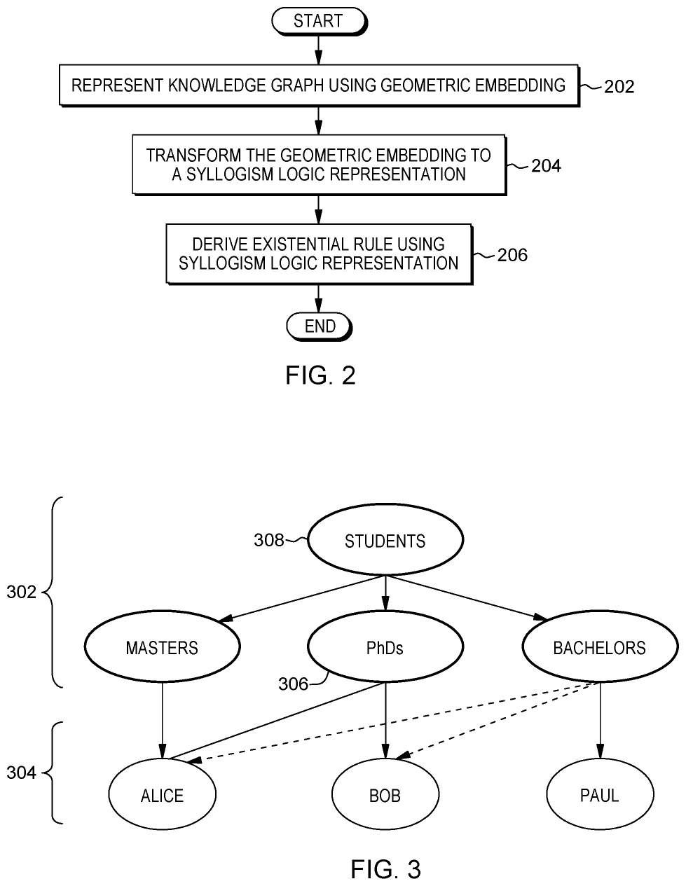

Turning now to the figures, FIG. 1 is a functional block diagram illustrating a rules generating environment 100, in accordance with an embodiment of the present invention. The environment 100 includes a rules generator 102 that generates existential rules 104 using a process illustrated in FIG. 2. The existential rules 104 represent a relationship between datapoints 106 within a knowledge graph 108. The datapoints 106 may be any of the subjects, predicates, or objects in the knowledge graph 108, and the rules generator 102 assigns the datapoints 106 as variables and atoms of the existential rules 104. This derivation of the existential rules 104 enables more efficient conclusions to be drawn by intelligent applications 110 interacting with the knowledge graph 108. The existential rules 104 include any relationship between the variables and atoms that may be represented by the notation:

R=∀x∀y(B[x,y]→∃zH[y,z])

That is, for all x vectors and all y vectors input into a body B, there exists a vector z for which there is a head having y and z vectors. Examples of existential rules 104 include:
isProject(x, y, z)→isMember(z, x) (i.e., every leader of a project is a member of this project)
Researcher(x) ∧ hasExpertise(x, y)→isProject(u, y, z) ∧ isMember(x, u) (i.e., every researcher expert in an area is member of a project in this area)
Researcher(x)→hasExpertise(x, y) (i.e., every researcher is expert in an area)

The rules generator 102 may access the knowledge graph 108 through a network connection 112, with the knowledge graph 108 located on an external storage device 114. The network connection 112 may also enable client devices 116 to have access to the knowledge graph 108 or the existential rules 104. The rules generator 102 derives the existential rules 104 in the knowledge graph 108 that includes classes 120. The knowledge graph 108 may include any number of classes 120. With the motivation and background for the rules generator 102 to create the existential rules 104, we turn to the process of creating the existential rules 104.

FIG. 2 is a flowchart depicting operational steps of a rules generating program 130, in accordance with an embodiment of the present invention. The rules generating program 130 represents the knowledge graph 108 using at least one geometric embedding 122 (block 202). Some examples of geometric embeddings include Poincaré Embeddings, Quantum embeddings, and box embeddings. Typically, the objective of embedding methods is to organize symbolic objects (e.g., the triples of the knowledge graph, the classes 120, words, entities, concepts) so that similar symbolic objects (i.e., semantic or functional similarity as understood by humans) reflect this similarity in a representative “embedding space.” The similarity of objects is usually measured either by their distance or by their inner product in the embedding space. For instance, pairs of words may be embedded in an embedding space such that an inner product between the words in the pair is maximized when the pair occurs in similar contexts. This is motivated by the hypothesis that the meaning of words can be derived from the contexts in which the words appear. Additionally, pairs of social actors may be embedded in a social network such that a distance between each respective pair is minimized if the social actors are connected in the network. Minimization of the distance between each pair reflects the homophily property found in many real-world networks, i.e. that similar actors tend to associate with each other.

FIG. 3 is a diagram depicting representations of geometric embeddings, in accordance with an embodiment of the present invention. The geometric embedding technique, as executed by the rule generating program 130, may also include dividing the classes 120 into TBox 302 and ABox 304 statements. The TBox 302 statements contain triples describing concept hierarchies (i.e., relations between concepts) while the ABox 304 statements contain ground triples stating where in the hierarchy individuals belong (i.e., relations between individuals and concepts). The geometric embeddings work to embed entities so that all entities in the super class are contained within the embedding space for the sub class. That is, the relationship present in the TBox 302 in the knowledge graph are preserved in the embedding space as well. For example, if Doctorate 306 is a subclass of Student 308, then a subspace embedding Student 308 will also cover the Doctorate 306 subspace as well.

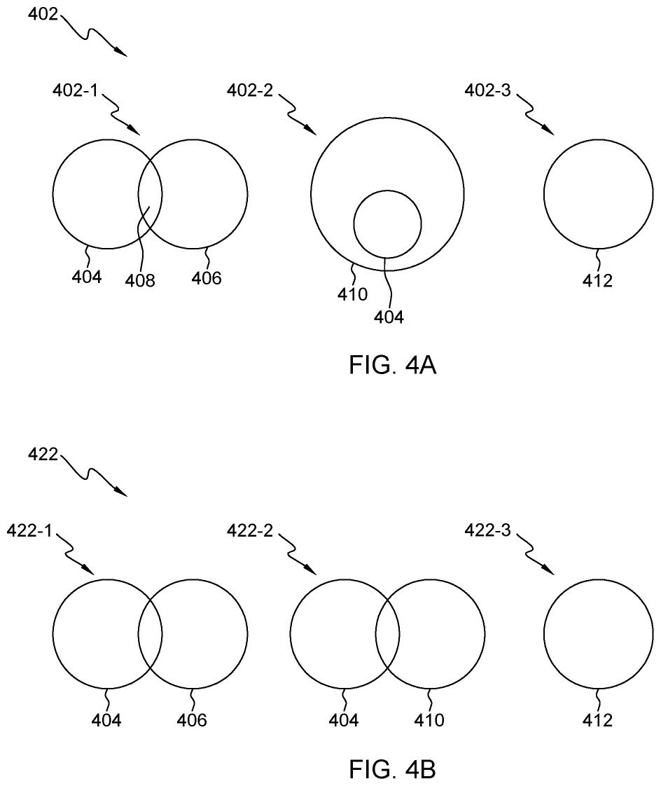

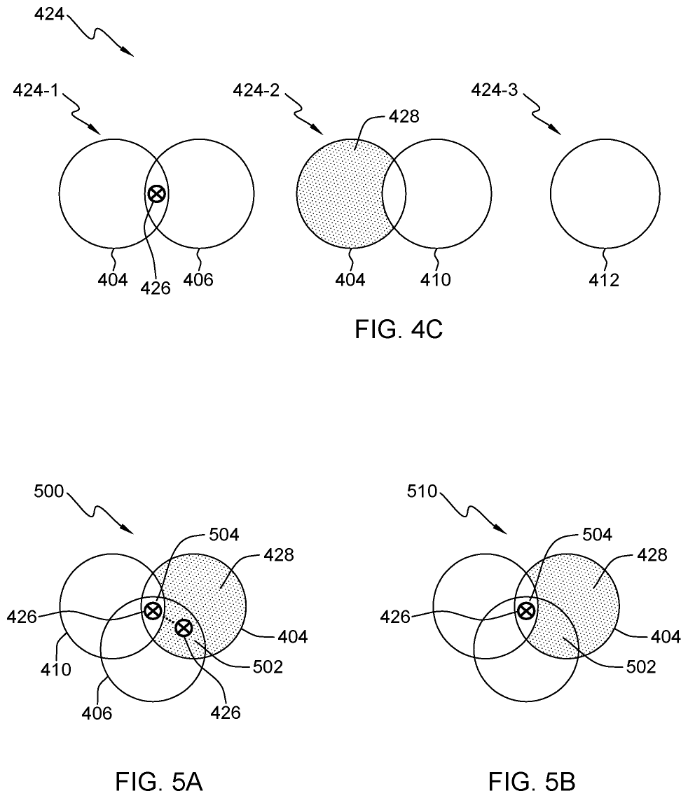

FIG. 4A is a chart representing geometric relationships 402 of the geometric embeddings derived by the rules generator 102 in accordance with one embodiment of the present invention. A first geometric relationship 402-1 illustrates a geometric embedding in which some examples of a first class 404 are also represented as examples of a second class 406. In the geometric embeddings represented in FIG. 3, the first class 404 may be a representation (generated by the rules generator 102) of the class of people having a master's degree while the second class 406 may be a representation of the class of people having a doctorate degree. A subset 408 of the people have both a master's and a doctorate degree, as represented by the overlap area in the first geometric relationship 402-1.

A second geometric relationship 402-2 illustrates a geometric embedding in which all examples of the first class 404 are included within a third class 410. The second geometric relationship 402-2 could illustrate, for example, the data represented in FIG. 3 with the third class 410 representing people with bachelor's degrees, and the first class 404 representing people with master's degrees. In this instance, every person that has a master's degree (i.e., represented by the first class 404) also has a bachelor's degree (i.e., represented by the third class 410). A third geometric relationship 402-3 illustrates a geometric embedding in which all examples of a fourth class 412 exist in the knowledge graph 108 without a relationship to any other class. The fourth class 412 may represent teaching assistants, for example, which is a designation that does not appear in the statements 302, 304 of FIG. 3, but may provide useful information about the knowledge graph 108 if meaningful existential rules 104 could be generated using the class.

The rules generating program 130 also transforms the geometric embedding to a syllogism logic representation 124 (block 204). A syllogism, as used herein, is an argument in which a conclusion is inferred from its premises. The syllogism is valid when the conclusion cannot be false when the premises of the syllogism are true. The transforming of the geometric embedding may include a two-step transformation, the first step being the transformation of geometric relationships (e.g., geometric relationships 402 illustrated in FIG. 4A) into Venn diagrams without shading and x-sequence (e.g., diagrams illustrated in FIG. 4B). The rules generating program 130 may construct and use premises to transform the geometric embedding to the syllogism logic representation. Premises may include forms between pairs of classes. For example, one premise may include an A Form, where all datapoints from one class are elements of another class. Another premise may include an E Form, where no datapoints from one class are elements of another class. Another premise may include an I Form, where some datapoints from one class are elements of another class. Another premise may include an O Form, where some datapoints from one class are not elements of another class. Another premise may include a Null Form, where no datapoints are included yet for a particular class.

FIG. 4B is a chart representing transformed geometric embeddings 422, as transformed by the rules generator 102 in accordance with one embodiment of the present invention. The rules generator 102 transforms the first geometric relationship 402-1 into the first transformed geometric relationship 422-1. The first transformed geometric relationship 422-1 is a Venn diagram, but looks similar to the first geometric relationship 402-1 only because of the form of the first geometric relationship 402-1. The second geometric relationship 402-2, for example, is not a Venn diagram, but the rules generator 102 transforms the second geometric relationship 402-2 into the second transformed geometric relationship 422-2, which is a Venn diagram. The third geometric relationship 402-3 does not have a relationship paired with another class, and therefore the third transformed geometric relationship 422-3 is the same as the third geometric relationship 402-3. Once the rules generator 102 finishes a first transformation, the rules generator 102 starts the second step of transforming the geometric embedding to a syllogism logic representation.

FIG. 4C is a chart depicting syllogism logic representations 424, in accordance with one embodiment of the present invention. The rules generator 102 transforms the transformed geometric embeddings 422 of FIG. 4B into the syllogism logic representations 424. This second transformation may employ the use of the premises described above. For example, the first transformed geometric relationship 422-1 is transformed (i.e., the second time) using the I form premise such that a first syllogism logic representation 424-1 includes an x-sequence 426 in an overlap area. The x-sequence 426 indicates that there is at least one datapoint 106 that is both the first class 404 and the second class 406.

The rules generator 102 also transforms the second transformed geometric relationship 422-2 into a second syllogism logic representation 424-2. The second syllogism logic representation 424-2 is transformed using an A form premise to shade a shaded area 428 indicating that all of the datapoints 106 in the first class 404 are datapoints in the third class 410. That is, the knowledge graph 108 does not have any datapoints 106 in the first class 404 unless the datapoints are also in the third class 410. The rules generator 102 transforms the third transformed geometric relationship 422-3 into the third syllogism logic representation 424-3 using the null premise, which still represents that the datapoints 106 are unrelated to other classes in the knowledge graph 108.

With the syllogism logic representations 124 transformed, the rules generating program 130 derives the existential rules 104 using standard transformation rules present in the syllogism logic representations 124 (block 206). The syllogism logic representations 124 have an advantage in the representation of partial knowledge, and can be combined to add successively more knowledge to the knowledge graph 108 as a whole, and to any applications accessing the knowledge graph 108. That is, when the rules generator 102 determines additional syllogism logic representations 124 the rules generator 102 can combine the syllogism logic representations 124 by putting in more x's 426 and shadings 428 into appropriate areas of a combination Venn diagram. This capability endows Venn diagrams with a more dynamic quality and enables us to manipulate diagrams to determine whether a syllogism is valid or not.

Deriving the existential rules 104 may include the application of manipulation rules (“MR”) to the syllogism logic representations 124. For example, the MRs may include Unification MRs, Resolution MRs, or Transformation MRs. Unification MRs unify each of the diagrams created above into a unified diagram. Resolution MRs resolve any conflicts on the unified diagram. Transformation MRs draw a conclusion diagram that represents the facts that the conclusion of an existential rule 104 conveys. The examples given below (i.e., in FIGS. 5A-10) illustrate existential rules 104 derived for low order knowledge graphs 108. The deriving of existential rules 104, however, may include any number of classes 120. For n number of classes 120, the rules generator 102 has the potential to evaluate 2′ syllogism logic representations 124. For large knowledge graphs 108, therefore, the rules generator 102 may selectively pick premises that derive useful existential rules 104 without requiring an evaluation of every syllogism logic representation 124 that is possible for the knowledge graph 108.

The Unification MRs include U.1: Copying circles to the unified diagram; U.2: Copying corresponding shadings to the unified diagram; U.3: Copying corresponding a-sequences to the unified diagram; and U.4: Inclusion of all compartments of a region in an a-sequence. FIG. 5A is a chart depicting a unified diagram 500, in accordance with an embodiment of the present invention. The unified diagram 500 is a unification of the first syllogism logic representation 424-1 and the second syllogism logic representation 424-2. In accordance with the Unification MRs, the rules generator 102: copies the first class 404, the second class 406, and the third class 410 to the unified diagram 500 (U.1); copies the shading 428 to the unified diagram 500 (U.2); copies the corresponding x-sequences 426 to the unification diagram 500 (U.3); and includes all of the compartments of a region in an a-sequence (i.e., while the x-sequence 426 in the first syllogism logic representation 424-1 only occupies one compartment, the x-sequence 426 in the unified diagram 500 occupies a first class 404-second class 406 compartment 502, and a first class 404-second class 406-third class 410 compartment 504).

Resolution MRs include R.1: determining an inconsistent diagram based on a-sequence and shading; and R.2: erasure of part of an x-sequence in a shaded compartment. R.1 applies to diagrams that have x-sequences that are entirely contained in shaded compartments. Such a diagram represents inconsistent information. That is, the knowledge graph 108 cannot have one datapoint 106 (represented by the x-sequence) and no datapoints 106 (represented by the shading) in the same combination of classes. The inconsistent diagram, as resolved by R.1, indicates that the underlying premises must be reconsidered.

FIG. 5B is a chart depicting a resolved unified diagram 510, in accordance with one embodiment of the present invention. The resolved unified diagram 510, in contrast to an inconsistent diagram resolved by R.1, resolves the unified diagram 500 according to the R.2. The x-sequence 426 occupying the shaded compartment 502 (i.e., the first class 404-second class 406 compartment) is erased in favor of the unshaded compartment 504 (i.e., the first class 404-second class 406-third class 410 compartment).

Once the rules generator 102 has combined information from the premises into the unified diagram using the Unification MRs, and then resolved any conflicts using the Resolution MRs, the next step is to transform the resolved unified diagram into a conclusion diagram using the Transformation MRs. The rules generator 102 uses two types of Transformation MRs: erasing information from the diagram, and extending an x-sequence. Specifically, the Transformation MRs include: T.1: Erasure of shading in a compartment; T.2: Erasure of a whole x-sequence; T.3: Erasure of a circle; T.3.a: A partial shading in a compartment; T.3.b: An x-sequence with more than one x-sequence in a compartment; T.4: Lengthening an x-sequence.

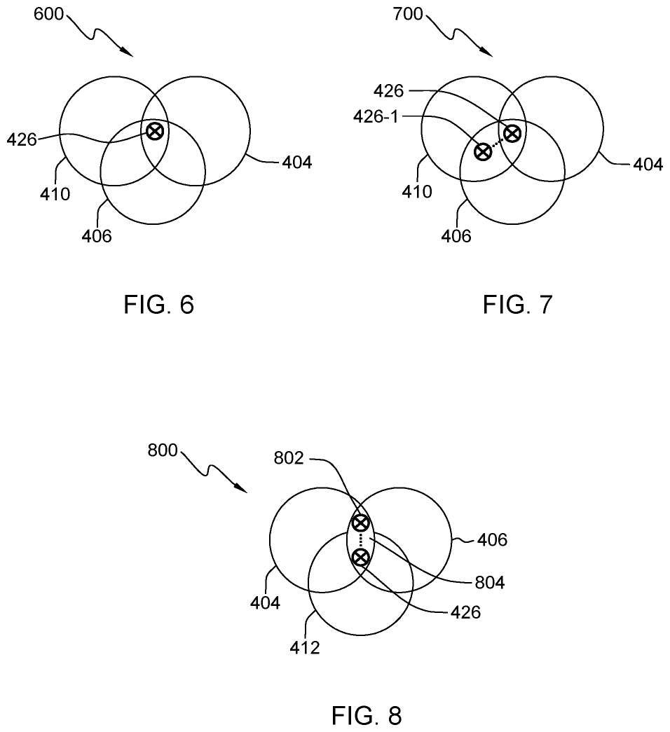

FIG. 6 is a chart depicting a conclusion diagram 600, in accordance with one embodiment of the present invention. The conclusion diagram 600 results from the rules generator 102 applying rule T.1 to the resolved unified diagram 510 of FIG. 5B. Transformation MR T.1 states that a shading may be erased. In the illustrated embodiment, the rules generator 102 has erased shading 428 to derive the existential rule 104: some of the first class 404 are the second class 406 and the third class 410. Harking back to the classes depicted in FIG. 3, the existential rule 104 concludes that for the datapoints 106 in the knowledge graph 108, some PhDs have a master's degree and a bachelor's degree. The rules generator 102 may then record this existential rule 104 for use by elsewhere, such as by the intelligent applications 110.

FIG. 7 is a chart depicting a conclusion diagram 700, in accordance with one embodiment of the present invention. The conclusion diagram 700 results from the rules generator 102 applying rule T.4 to the conclusion diagram 600 of FIG. 6. Transformation MR T.4 states that an x-sequence 426 may be added (any number of times) to an existing a-sequence 426. In the illustrated embodiment, the rules generator 102 has added new a-sequence 426-1 to derive the existential rule 104: some of the second class 406 are the third class 410. Harking back to the classes depicted in FIG. 3, the existential rule 104 concludes that, for the datapoints 106 in the knowledge graph 108, some PhDs are Bachelors. The rules generator 102 may then record this existential rule 104 for use by elsewhere, such as by the intelligent applications 110.

FIG. 8 is a chart depicting a unified diagram 800, in accordance with an embodiment of the present invention. The unified diagram 800 is a unification of the first syllogism logic representation 424-1 and the third syllogism logic representation 424-3. In accordance with the Unification MRs, the rules generator 102: copies first class 404, the second class 406, and the fourth class 412 to the unified diagram 800 (U.1); copies the corresponding x-sequences 426 to the unification diagram 500 (U.3); and includes all of the compartments of a region in an x-sequence (U.4) (i.e., while the x-sequence 426 in the first syllogism logic representation 424-1 only occupies one compartment, the x-sequence 426 in the unified diagram 800 occupies a first class 404-second class 406 compartment 802, and a first class 404-second class 406-fourth class 412 compartment 804).

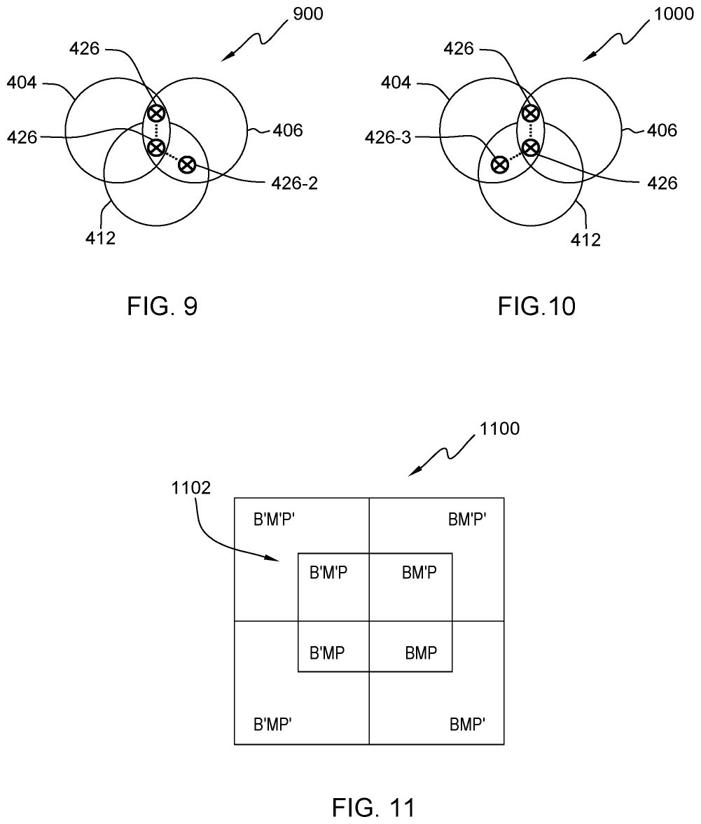

FIG. 9 is a chart depicting a conclusion diagram 900, in accordance with one embodiment of the present invention. The conclusion diagram 900 results from the rules generator 102 applying rule T.4 to the unified diagram 800 of FIG. 8. Transformation MR T.4 states that an x-sequence 426 may be added (any number of times) to an existing a-sequence 426. In the illustrated embodiment, the rules generator 102 has added new a-sequence 426-2 to derive the existential rule 104: some of the second class 406 are the fourth class 412. Harking back to the classes depicted in FIG. 3, the existential rule 104 concludes that, for the datapoints 106 in the knowledge graph 108, some PhDs are teacher's assistants (TAs). The rules generator 102 may then record this existential rule 104 for use by elsewhere, such as by the intelligent applications 110.

FIG. 10 is a chart depicting a conclusion diagram 1000, in accordance with one embodiment of the present invention. The conclusion diagram 1000 results from the rules generator 102 applying rule T.4 to the unified diagram 800 of FIG. 8. Transformation MR T.4 states that an x-sequence 426 may be added (any number of times) to an existing a-sequence 426. In the illustrated embodiment, the rules generator 102 has added new a-sequence 426-3 (different than the new x-sequence 426-2 in FIG. 9) to derive the existential rule 104: some of the first class 404 are the fourth class 412. Harking back to the classes depicted in FIG. 3, the existential rule 104 concludes that, for the datapoints 106 in the knowledge graph 108, some Masters are TAs. The rules generator 102 may then record this existential rule 104 for use by elsewhere, such as by the intelligent applications 110.

Venn diagrams are not the only way that the rules generator 102 may transform geometric embeddings to syllogism logic representations and derive existential rules. A variety of logic representations may be used to derive the existential rules 104 from the knowledge graph 108. For example, one additional representation that the rules generator 102 may use is a Carroll's Diagram. FIG. 11 is a chart depicting a Carroll's representation 1100 of three classes 120. In the representation 1100, the classes 120 are indicated by variable designations: B (right half), M (bottom half), and P (inner box), with “not” indicated by the apostrophe variable designations: B′ (left half), M′ (top half), and P′ (outside the inner box). The rules generator 102 populates cells 1102 of the representation 1100 to show whether the knowledge graph 108 has datapoints 106 with that combination of classes 120. The populated representation 1100 is how the rules generator 102 represents the syllogism logic representations 124 (block 204) when using Carroll's Diagrams. The syllogism logic representations 124 in a Carroll's Diagram representation 1100 include: 0 if there is no datapoint 106 in the cell 1102; 1 if the cell 1102 is not empty; 1 on the border between two cells 1102 if at least one of the two cells 1102 is not empty.

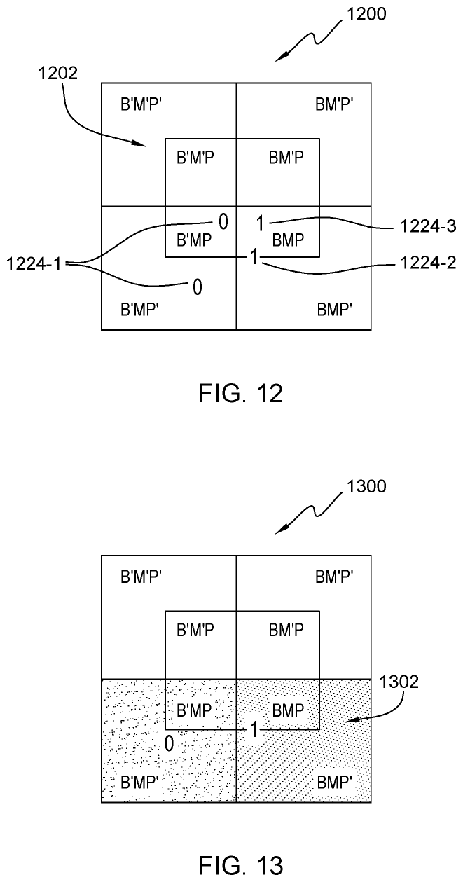

FIG. 12 is a chart depicting a trilateral diagram 1200 of syllogism logic representations 1224, in accordance with one embodiment of the present invention. The rules generator 102 transforms the initial set of conditions: “some PhDs are Masters,” and “all Masters are Bachelors” into the syllogism logic representations 1224. To do so, the rules generator 102, employs premises: R1 break up any “all” propositions into two equivalent propositions; and R2 represent “no” propositions first by placing a ‘0’ in the appropriate cell, then represent “some” propositions by placing a ‘1’ in the appropriate cell.

Employing these premises, the rules generator 102 breaks up the proposition “All Masters are Bachelors” into “some Masters are Bachelors” and “no Masters is not Bachelors.” The rules generator 102 then maps a first syllogism logic representation 1224-1 for “no Masters is not Bachelors” by marking cells 1202 marked “B′MP” and “B′MP′” with a 0. The rules generator 102 then maps a second syllogism logic representation 1224-2 for “some Masters are Bachelors” by marking the border between cells 1202 “BMP” and “BMP′” with a 1. The rules generator 102 also maps a third syllogism logic representation 1224-3 for “some PhDs are Masters” by marking the cell 1202 marked “BMP” with a 1.

The rules generator 102 may then derive existential rules 104 by using transformation rules that are standard for the Carroll's Diagrams. The transformation rules dictate that for each quarter of the trilateral diagram 1200, select one of three options: if there is a ‘1’ in either cell, mark the quarter with a ‘1’; if there is a ‘0’ in both cells, mark the quarter with a ‘0’; or else transfer nothing. The result of the transformation rules is a bilateral diagram that gives the complete conclusion (if it exists) of the syllogism.

FIG. 13 is a chart depicting a bilateral diagram 1300 as transformed by the transformation rules, in accordance with one embodiment of the present invention. The bilateral diagram 1300 shows the derived rule 1302 that some PhDs are Bachelors.

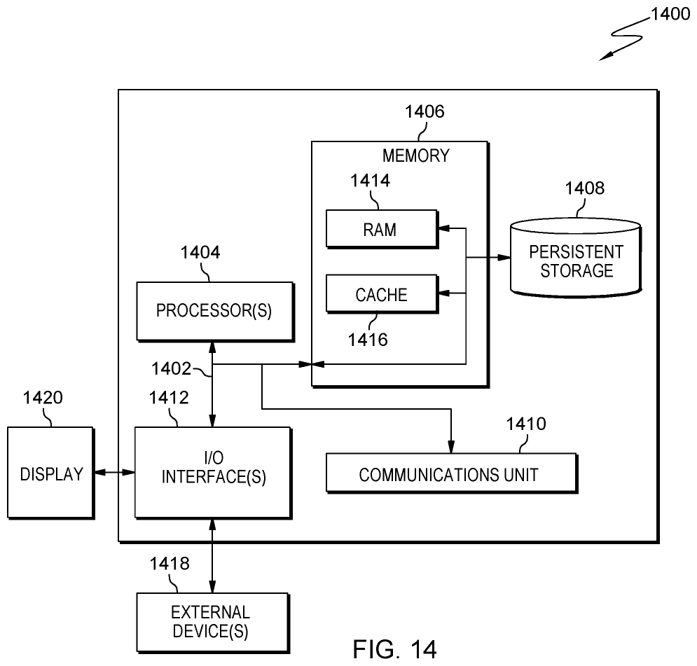

FIG. 14 depicts a block diagram of components of a computing device 1400 in accordance with an illustrative embodiment of the present invention. As described above, the computing device 1400 may represent any of the devices (e.g., client device 116, rules generator 102, and/or external storage device 114) described above, or a combination of the devices, in the embodiments where the devices are embodied as components of a single computing device 1400. It should be appreciated that FIG. 14 provides only an illustration of one implementation and does not imply any limitations with regard to the environments in which different embodiments may be implemented. Many modifications to the depicted environment may be made.

The computing device 1400 includes communications fabric 1402, which provides communications between RAM 1414, cache 1416, memory 1406, persistent storage 1408, communications unit 1410, and input/output (I/O) interface(s) 1412. Communications fabric 1402 can be implemented with any architecture designed for passing data and/or control information between processors (such as microprocessors, communications and network processors, etc.), system memory, peripheral devices, and any other hardware components within a system. For example, communications fabric 1402 can be implemented with one or more buses or a crossbar switch.

Memory 1406 and persistent storage 1408 are computer readable storage media. In this embodiment, memory 1406 includes random access memory (RAM). In general, memory 1406 can include any suitable volatile or non-volatile computer readable storage media. Cache 1416 is a fast memory that enhances the performance of computer processor(s) 1404 by holding recently accessed data, and data near accessed data, from memory 1406.

The software components (e.g., rules generating program 130) may be stored in persistent storage 1408 and in memory 1406 for execution and/or access by one or more of the respective computer processors 1404 via cache 1416. In an embodiment, persistent storage 1408 includes a magnetic hard disk drive. Alternatively, or in addition to a magnetic hard disk drive, persistent storage 1408 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 1408 may also be removable. For example, a removable hard drive may be used for persistent storage 1408. Other examples include optical and magnetic disks, thumb drives, and smart cards that are inserted into a drive for transfer onto another computer readable storage medium that is also part of persistent storage 1408.

Communications unit 1410, in these examples, provides for communications with other data processing systems or devices. In these examples, communications unit 1410 includes one or more network interface cards. Communications unit 1410 may provide communications through the use of either or both physical and wireless communications links. The proxy, application, access manager, collection page, authentication tool, or multi-factor authentication page may be downloaded to persistent storage 1408 through communications unit 1410.

I/O interface(s) 1412 allows for input and output of data with other devices that may be connected to the computing device 1400. For example, I/O interface 1412 may provide a connection to external devices 1418 such as a keyboard, keypad, a touch screen, and/or some other suitable input device. External devices 1418 can also include portable computer readable storage media such as, for example, thumb drives, portable optical or magnetic disks, and memory cards. Software and data used to practice embodiments of the present invention (e.g., rule generating program 130) can be stored on such portable computer readable storage media and can be loaded onto persistent storage 1408 via I/O interface(s) 1412. I/O interface(s) 1412 also connect to a display 1420.

Display 1420 provides a mechanism to display data to a user and may be, for example, a computer monitor.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method for deriving existential rules from knowledge graph data, comprising:
representing a knowledge graph using a geometric embedding;
transforming the geometric embedding to a syllogism logic representation using a geometric relationship; and
deriving existential rules using standard transformation rules present in the syllogism logic representation.

2. The method of claim 1, wherein the syllogism logic representation comprises a selection from the group consisting of: a Venn diagram with shading and x-sequences, and a Carroll's diagram.

3. The method of claim 1, comprising constructing a set of premises defining syllogistic forms for classes of the knowledge graph.

4. The method of claim 3, wherein transforming the geometric embedding to the syllogisms logic representation comprises applying the set of premises to the geometric embedding.

5. The method of claim 1, wherein deriving the existential rules comprises applying a selection from the group consisting of unification rules, resolution rules, and transformation rules.

6. The method of claim 1, wherein the knowledge graph comprises classes.

7. The method of claim 1, wherein the geometric embedding comprises concept hierarchies.

8. A computer program product for deriving existential rules from knowledge graph data, comprising:
one or more computer readable storage media, and program instructions collectively stored on the one or more computer readable storage media, the program instructions comprising:
program instructions to represent a knowledge graph using a geometric embedding;
program instructions to transform the geometric embedding to a syllogism logic representation using geometric relationships; and
program instructions to derive existential rules using standard transformation rules present in the syllogism logic representation.

9. The computer program product of claim 8, wherein the syllogism logic representation comprises a selection from the group consisting of: a Venn diagram with shading and a-sequences, and a Carroll's diagram.

10. The computer program product of claim 8, comprising program instructions to construct a set of premises defining syllogistic forms for classes of the knowledge graph.

11. The computer program product of claim 10, wherein transforming the geometric embedding to the syllogisms logic representation comprises applying the set of premises to the geometric embedding.

12. The computer program product of claim 8, wherein deriving the existential rules comprises applying a selection from the group consisting of unification rules, resolution rules, and transformation rules.

13. The computer program product of claim 8, wherein the knowledge graph comprises classes.

14. The computer program product of claim 8, wherein the geometric embedding comprises concept hierarchies.

15. A computer system for deriving existential rules from knowledge graph data, comprising:
one or more computer processors, one or more computer readable storage media, and program instructions collectively stored on the one or more computer readable storage media for execution by at least one of the one or more computer processors, the program instructions comprising:
program instructions to represent a knowledge graph using a geometric embedding;
program instructions to transform the geometric embedding to a syllogism logic representation using geometric relationships; and
program instructions to derive existential rules using standard transformation rules present in the syllogism logic representation.

16. The computer system of claim 15, wherein the syllogism logic representation comprises a selection from the group consisting of: a Venn diagram with shading and x-sequences, and a Carroll's diagram.

17. The computer system of claim 15, comprising program instructions to construct a set of premises defining syllogistic forms for classes of the knowledge graph.

18. The computer system of claim 17, wherein transforming the geometric embedding to the syllogisms logic representation comprises applying the set of premises to the geometric embedding.

19. The computer system of claim 15, wherein deriving the existential rules comprises applying a selection from the group consisting of unification rules, resolution rules, and transformation rules.

20. The computer system of claim 15, wherein the knowledge graph comprises classes.

21. The computer system of claim 15, wherein the geometric embedding comprises concept hierarchies.

22. A computer-implemented method for deriving rules for a knowledge graph, comprising:
dividing a knowledge graph into classes;
organizing geometric embeddings for entities in the knowledge graph;
constructing premises, wherein the premises comprise syllogistic relationships for a pair of classes;
transforming the geometric embeddings into Venn diagrams;
transforming the Venn diagrams into Venn diagrams with shading and x-sequence using the premises; and
deriving conclusive rules using the Venn diagrams with shading and x-sequence.

23. The method of claim 22, wherein the geometric embedding comprises concept hierarchies.

24. A computer-implemented method for deriving rules for a knowledge graph, comprising:
dividing a knowledge graph into classes;
organizing geometric embeddings for entities in the knowledge graph;
constructing premises, wherein the premises comprise syllogistic relationships for a pair of classes;
transforming the geometric embeddings into Carroll's diagrams;
transforming, using the premises, the Carroll's diagrams into transformed Carroll's diagrams; and
deriving conclusive rules using the transformed Carroll's diagrams.

25. The method of claim 24, wherein the transformed Carroll's diagrams comprise a selection from the group consisting of: 1's and 0's.
